(19) United States
(12) Patent Application Publication
(10) Pub. No.: US 2007/0180676 A1
(43) Pub. Date: Aug. 9, 2007

(54) Method of and tool for calibrating transfer apparatus

(76) Inventor: Kyu-Hyuk Hwang, Hwaseong-si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/655,157

(22) Filed: Jan. 19, 2007

(30) Foreign Application Priority Data
Feb. 6, 2006 (KR) 2006-11328

(51) Int. Cl. B23P 11/00; B23P 21/00; B21D 39/03

(52) U.S. Cl. 29/407.01; 29/705; 29/407.05; 29/428

(57) ABSTRACT

A transfer apparatus installed in a transfer chamber of substrate processing equipment can be precisely calibrated with respect to a substrate support of a process chamber. Also, the calibration can be performed while a vacuum pressure is maintained in the transfer chamber. The tool for calibrating the transfer apparatus includes a base plate and a light source mounted to the base plate. The base plate is mounted to the process chamber, and the light source is positioned and oriented to direct a beam of light onto a reference mark on the substrate support. Then, an end effecter of the transfer apparatus is moved to a transfer position over the substrate support. The end effecter has a reference hole that is aligned with the reference mark when the end effecter is in a centered state relative to the substrate support. The beam of light is used to determine whether the reference hole is aligned with the reference mark.

### BACKGROUND OF THE INVENTION

1. Field of the Invention

The present invention relates to multi-chambered manufacturing equipment having a plurality of modules each including a chamber, and a transfer apparatus for transferring substrates between the chambers of the equipment. More specifically, the present invention relates to a tool for calibrating the transfer apparatus, and to a method of calibrating a process of transferring a substrate to a process module.

2. Description of the Related Art

Semiconductor device manufacturing equipment is complex equipment that often includes a plurality of process modules which process substrates such as semiconductor wafers, load-lock modules which accommodate cassettes that store the substrates, a transfer chamber to which the process and load-lock modules are commonly connected, and a substrate transfer robot disposed in the transfer chamber. In one such type of semiconductor device manufacturing equipment, known as cluster equipment, the transfer chamber has numerous sides, e.g., is hexagonal or octagonal, and the process and load-lock modules are attached to the sides of the transfer chamber, respectively.

The transfer robot transfers substrates into and out of the various chambers of the modules that are attached to the transfer chamber. For example, the transfer robot is operative to withdraw a substrate from (a cassette in) a load-lock chamber, transfer the substrate through the transfer chamber and into a process chamber, subsequently transfer a processed substrate out of a process chamber and back into the transfer chamber, and finally load the processed substrate into (a cassette disposed in) a load-lock chamber. Therefore, it is very important to accurately calibrate the substrate transfer robot. Typically, this is done during regular preventive maintenance (PM) of the equipment as well as at the time a manufacturing sequence is initiated.

In a conventional method of calibrating the transfer robot of cluster equipment, an operator centers an end effecter (a substrate supporting portion) of a transfer robot relative to a susceptor located inside the process chamber. This centering operation is carried out by eye using a window provided in the process chamber. Therefore, the calibration of the end effecter of the transfer robot depends on the operator's skill level. Accordingly, sometimes the end effecter of the transfer robot is not centered precisely relative to the susceptor in the process module. In this case, a substrate transferred into the process module by the transfer robot is not aligned with the susceptor. As a result, the substrate can be damaged during its transfer or the processing of the substrate may not have the desired results.

In another calibration method, an upper cover of the process chamber is opened, and a calibration tool having a pin is disposed on a susceptor having a groove in the center of its upper surface. After that, the calibration pin is used to check whether the groove in the susceptor is aligned with a hole in the center of the end effecter. However, according to this method, both the process chamber and the transfer chamber are exposed to the environment outside the equipment for a long time. Therefore, there is a high possibility that not only the process chamber but also the transfer chamber will be contaminated. Also, the process chamber and the transfer chamber must be evacuated after this calibration process to restore the process pressure (vacuum) in the chambers. Evacuating the chambers, especially the transfer chamber which has a much larger volume than the process chamber, takes a significant amount of time. Thus, this method of calibrating the transfer robot negatively impacts the yield of the manufacturing process.

### SUMMARY OF THE INVENTION

An object of the present invention is to provide a tool by which a transfer apparatus of multi-chambered processing equipment can be precisely calibrated.

Another object of the present invention is to provide in combination with substrate processing equipment a calibration tool by which a transfer apparatus of the equipment can be calibrated without a need for the equipment to be down for a long period of time.

Another object of the present invention is to provide multi-chambered substrate processing equipment having a transfer apparatus in combination with a calibration tool by which the transfer apparatus of the equipment can be calibrated while minimizing the likelihood that the chambers of the equipment will be contaminated.

Similarly, an object of the present invention is to provide a method of operating multi-chambered processing equipment, including steps by which a transfer apparatus of the equipment can be calibrated while minimizing the likelihood that the chambers of the equipment will be contaminated.

Another object of the present invention is to provide a method of operating multi-chambered processing equipment, including steps by which a transfer apparatus of the equipment can be calibrated swiftly and precisely.

According to one aspect of the present invention, there is provided the combination of substrate processing equipment, and a transfer apparatus calibration tool by which a transfer apparatus installed in a transfer chamber of the equipment can be calibrated with respect to a process module of the equipment while a vacuum is maintained in the transfer chamber.

According to another aspect of the present invention, there is provided the combination of substrate processing equipment, and a transfer apparatus calibration tool by which a transfer apparatus installed in a transfer chamber of the equipment can be calibrated with respect to a process module of the equipment with a high degree of precision and rapidly irrespective of the skill level of a technician in charge of operating the equipment.

The transfer apparatus includes an end effecter having a working envelope encompassing a process chamber of the process module such that the end effecter can be moved to a transfer position at which substrates are transferred between the end effecter and a substrate support disposed within the process chamber. The transfer apparatus calibration tool can be used to determine whether the end effecter is in a centered state relative to the substrate support when the end effecter is at the transfer position. To this end, the transfer apparatus calibration tool includes a base plate disposed on the process chamber, and an optical system supported by the base plate. An optical path of the optical system extends towards the substrate support. The end effecter is disposed in the optical path of the optical system when the end effecter is at the transfer position.

The end effecter of the transfer apparatus has a reference hole extending therethrough, and the substrate support has a reference mark thereon. The reference hole of the end effecter and the reference mark of the substrate support are aligned with the optical path of the optical system of the calibration tool when the end effecter is at the transfer position while in a centered state relative to the substrate support.

Also, the process chamber has a removable-cover. The base plate of the transfer apparatus calibration tool has a shape corresponding to that of the cover and is detachably mounted to the process chamber. Therefore, the calibration tool can be exchanged with the removable cover of the process chamber.

According to another aspect of the present invention, the transfer apparatus calibration tool includes a light source mounted on the base plate. At least a portion of the base plate may be formed of transparent material so the inside of the process chamber can be viewed from outside the process chamber. Also, the light source may be supported so as to be movable relative to the base plate so that the position of the light source relative to the base plate can be adjusted.

Preferably, the means by which the light source is supported is an X-Y stage mounted to the base plate. The X-Y stage has a first block supported so as to be movable relative to the base plate in the direction of an X-axis, and a second block supported by the first block so as to be movable with the first block in the direction of the X-axis and relative to the first block in the direction of a Y-axis perpendicular to the X-axis. The light source is attached to the second block.

The transfer apparatus calibration tool may also have a light detector mounted to the base plate. The light detector is positioned to receive light emitted by the light source and reflected within the process chamber by the reference mark of the substrate support or the end effecter of the transfer apparatus.

According to another aspect of the present invention, a method for use in operating multi-chambered substrate processing equipment includes removing a cover of a process chamber of the equipment while an input/output port defined between the process chamber and a transfer chamber of the equipment is closed, mounting a transfer apparatus calibration over the uncovered portion of the process chamber to hermetically seal the process chamber, creating a vacuum inside the process chamber, then opening the input/output port and moving an end effecter of a transfer apparatus from the transfer chamber into the process chamber via the input/output port, and calibrating the end effecter in the process chamber using the transfer apparatus calibration tool.

The calibrating of the end effecter entails determining whether the end effecter is in a centered state relative to a substrate support disposed in the process chamber. This may be accomplished by directing a beam of light onto a reference mark of the substrate support before the end effecter has been moved into the process chamber, and subsequently determining whether the light passes through a reference hole extending through the end effecter once the end effecter has been moved into the process chamber. In this respect, the beam of light can be detected after the light has been reflected in the process chamber. The detected light can then be processed to determine whether the beam of light was reflected at the reference mark of the substrate support or at a surface of the end effecter.

Thus, according to another aspect of the present invention, a method for use in operating multi-chambered substrate processing equipment includes creating a vacuum inside a process chamber of the equipment, then opening an input/output port and moving an end effecter of a transfer apparatus from a transfer chamber and into the process chamber via the input/output port, and calibrating the end effecter in the process chamber using a beam of light and while a vacuum exists in the process chamber. First, the beam of light is directed onto a reference mark of the substrate support. Then, the end effecter is moved to a transfer position in the process chamber, and a determination is made as to whether the light passes through a reference hole extending through the end effecter while the end effecter is at the transfer position.

### BRIEF DESCRIPTION OF THE DRAWINGS

These and other objects, features and advantages of the present invention will become clearer from the following detailed description of the preferred embodiments thereof with made with reference to the accompanying drawings. Note, like reference numerals designate like parts throughout the various drawings. In the drawings:

FIG. 1 is a plan view of a transfer robot calibration tool according to the present invention;

FIG. 2 is a side view of the transfer robot position calibration tool illustrated in FIG. 1;

FIG. 3 is a schematic view of a cluster type of manufacturing equipment;

FIGS. 4A through 4G are each a side view, partially in section, of a portion of the cluster type of manufacturing equipment illustrated in FIG. 3 and respectively illustrate steps in a process of calibrating an end effecter of a transfer robot of the equipment; and

FIG. 5 is a flowchart of a method of calibrating a process of transferring a substrate into a process chamber of manufacturing equipment.

### DETAILED DESCRIPTION OF THE PREFERRED EMBODIMENTS

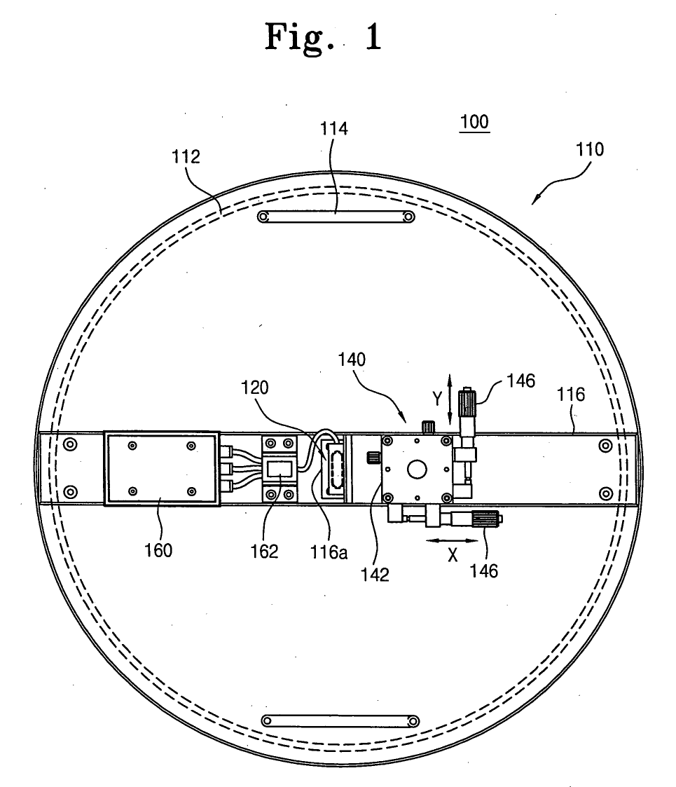

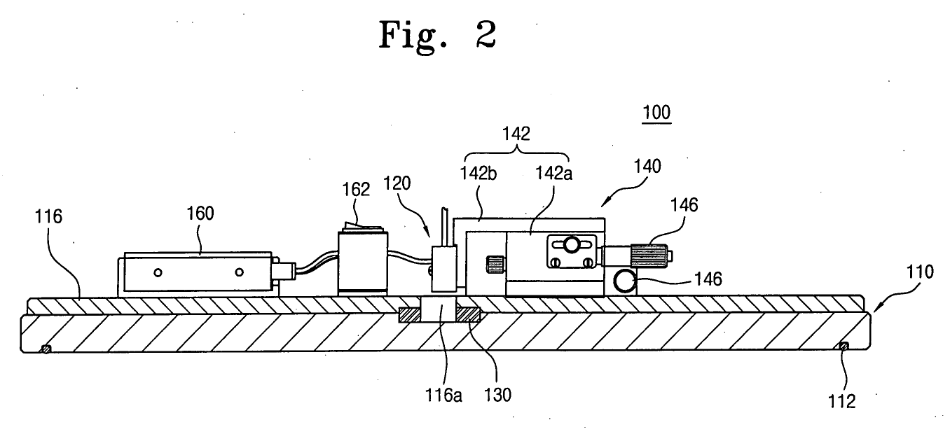

Referring to FIGS. 1 and 2 a transfer robot position calibration tool 100 according to the present invention includes a base plate 110, a light generator 120, a light detector 130, and a position adjustor 140.

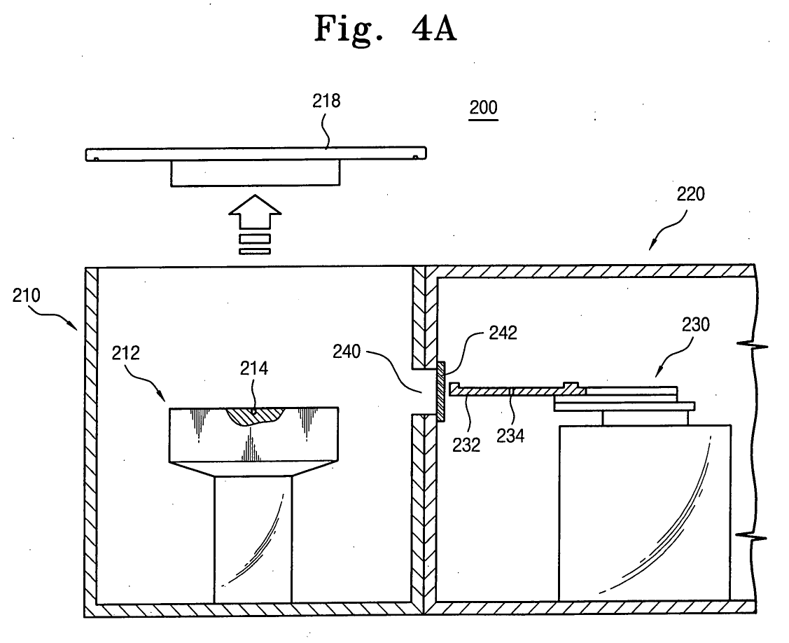

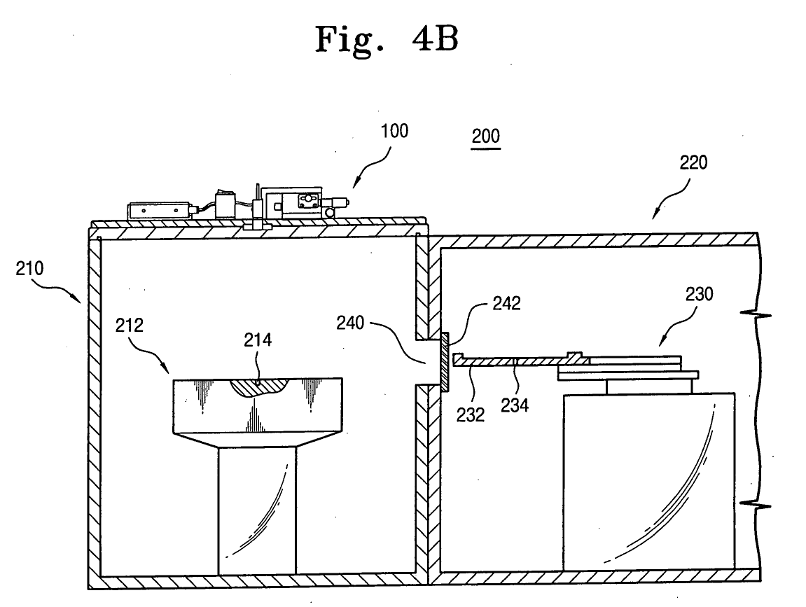

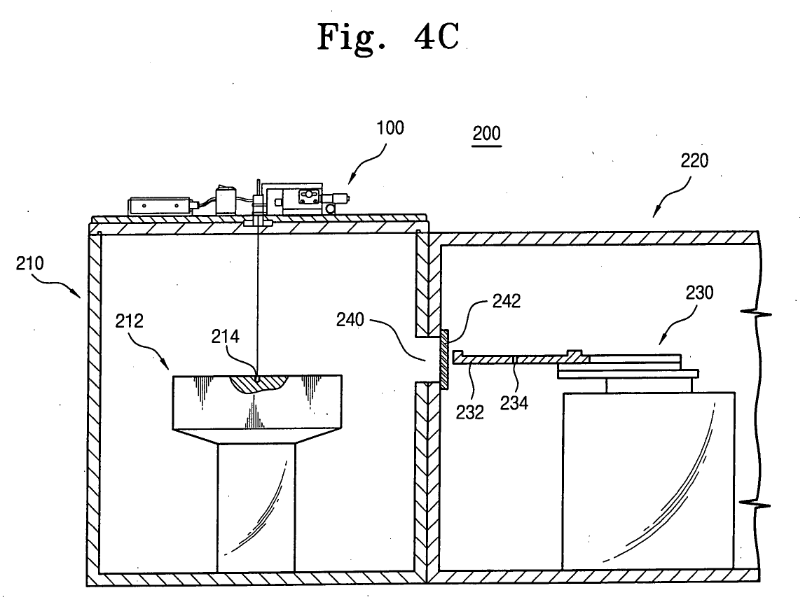

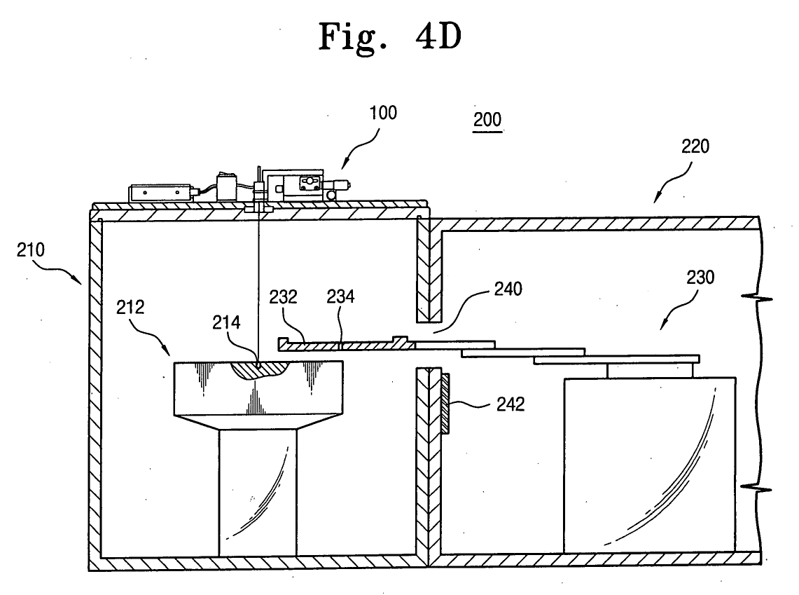

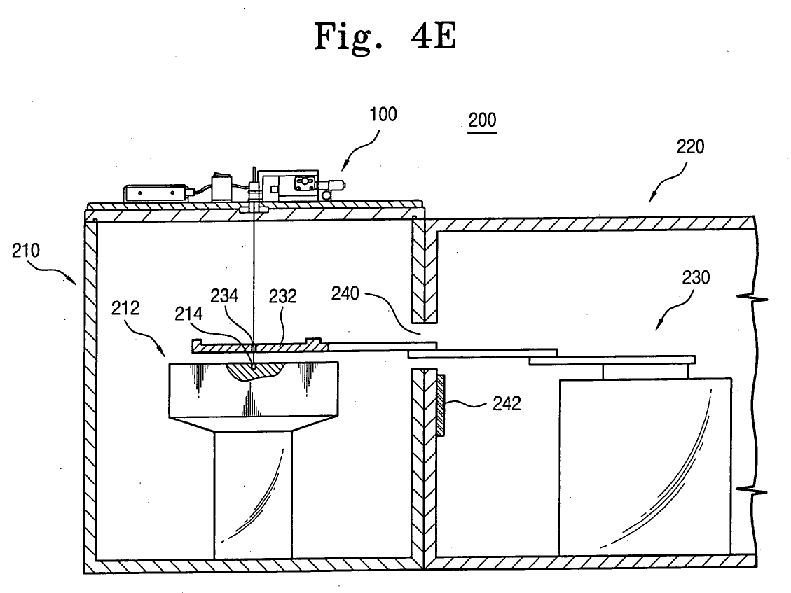

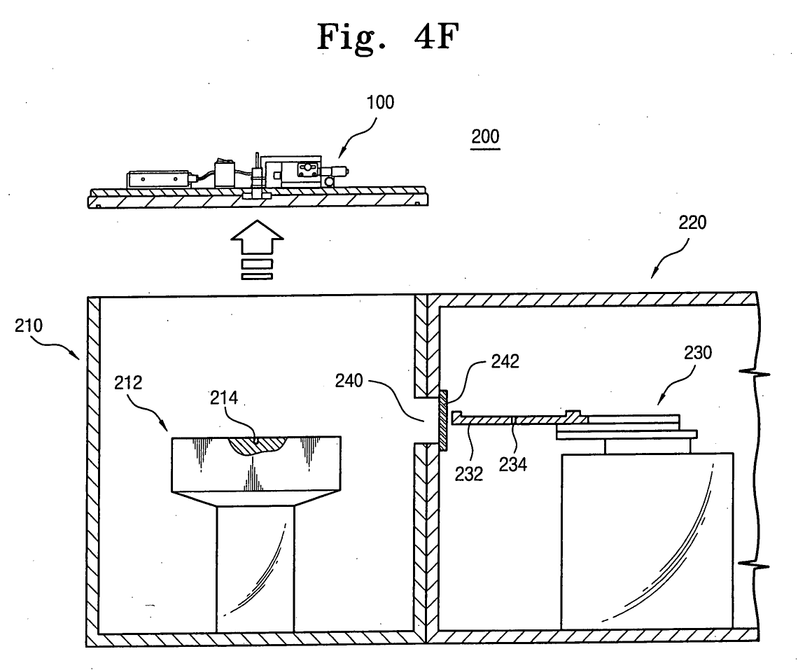

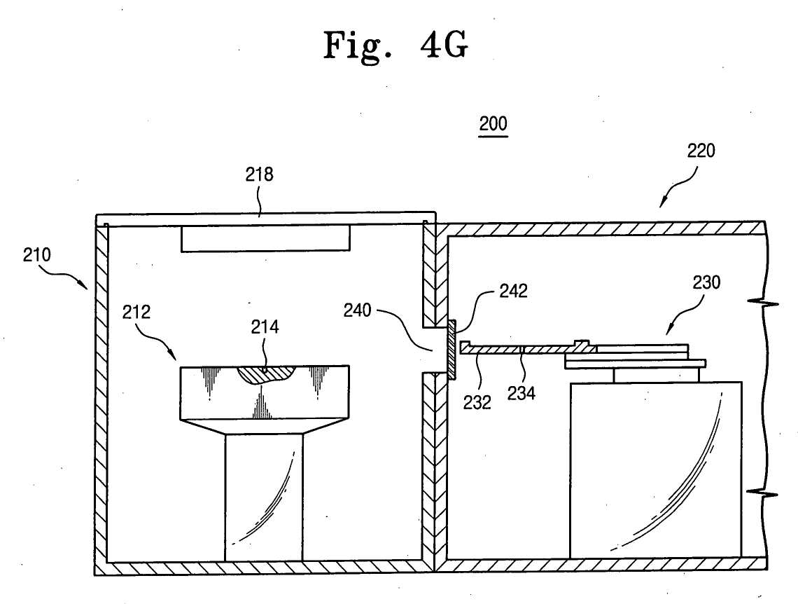

Referring also to FIGS. 4A-4G, the base plate 110 comprises transparent material. More specifically, the entire base plate 110 can be transparent or the base plate 110 can include a window so that an operator may look through. Also, the base plate 110 may have a size similar to that of a removable upper cover 218 of a process chamber 210. The upper cover 218, when in place, may form the entire top of the process chamber or only a portion of the top of the process chamber 210. Thus, the base plate 218 conforms to an open upper portion of the top of the process chamber 210 when the cover 218 is removed. A seal 112 extends along the periphery of a lower surface of the base plate 110 for creating a seal between the base plate 110 and the process chamber 210.

One or more handles 114 are attached to the base plate 110 to allow the calibration tool 100 to be easily handled and transported. The calibration tool 100 also includes a support plate 116 mounted on an upper surface of the base plate 110. The light generator 120, the light detector 130, and the position adjustor 140 are installed on the support plate 116. An opening 116a extends through the support plate 116 below the light generator 120.

The light generator 120 emits a laser beam through the base plate 110 and preferably in a direction perpendicular to the base plate 110. A battery 160 is provided as a power source for the light generator 120. An on/off switch 162 is connected between the battery 160 and the light generator 120 for cutting off or allowing power to be supplied from the battery 160 to the light generator 120. The light detector 130 is disposed at a position to receive the laser beam after it has been reflected. Thus, the light detector 130 can be installed on an upper surface of the base plate 110 or on a lower surface of the support plate 116 (as shown) depending on the angle of reflection of the laser beam emitted by the light generator.

The position adjustor 140 can move the light generator 120 on the support plate 116 along an X-axis and a Y-axis perpendicular to the X-axis. To this end, the position adjustor 140 includes an X/Y stage 142 disposed on the support plate 116, and adjusting screws 146 for moving the X/Y stage 142 in X and Y directions, respectively. Such an X/Y stage 142 is known per se and has dovetail couplings that guide respective blocks of the stage 142 for movement along straight lines. That is, the X/Y moving stage 142 includes a first block 142a coupled to the support plate 116 with a dovetail such that the first block 142 can slide in the direction of the Y-axis, and a second block 142b coupled to the first block 142a with a dovetail such that the second block 142b moves with the first block 142a in the direction of the Y-axis but can slide relative to the first block 142a in the direction of the X-axis. The light generator 120 is mounted to the second block 142a so that it moves-along with the first and second blocs 142a, 142b. The light generator 120 is positioned by the position adjustor 140 so that the laser beam is directed through the opening 116a in the support plate 116 and hence, through the base plate 110.

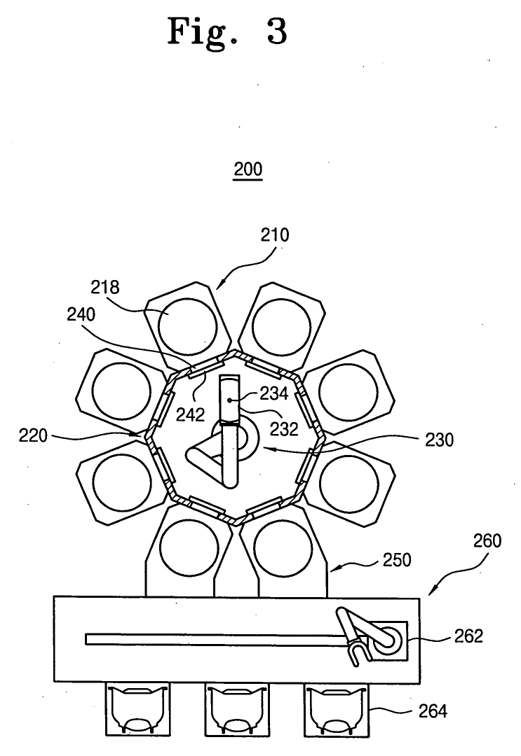

The transfer robot position calibration tool 100 having the above-described structure can be used in cluster equipment that has a plurality of process chambers connected via a central transfer chamber. FIGS. 3 and 4A-4E illustrate an example of cluster equipment provided with a transfer robot calibration tool according to the present invention.

Referring to FIGS. 3 and 4A-4G, the cluster equipment 200 includes a central transfer chamber 220, a transfer robot 230 disposed in the central transfer chamber 220, and a plurality of chambers connected to sides of the central transfer chamber 220, respectively. The chambers include at least one process chamber 210 in which a substrate is processed, at least one loadlock chamber 250, and the chamber(s) of one or more auxiliary apparatus. The process chambers 210 may be the chambers of apparatus used in the manufacturing of semiconductor devices, such as a chemical vapor deposition (CVD) apparatus, an atomic layer deposition (ALD) apparatus, a physical vapor apparatus (PVD) chamber, or an etching apparatus. The auxiliary apparatus may include a pre-cleaning apparatus, a heat treatment apparatus, a wafer alignment apparatus, and/or a gas removal apparatus. However, because the present invention is applicable to any of the chambers connected to the transfer chamber 220 and into and from which a substrate can be transferred by the transfer robot 230, all of such chambers will be referred to hereinafter as process chambers.

The cluster equipment 200 also has an input/output port 240 defined between the transfer chamber 220 and each chamber connected to the transfer chamber 220 to allow a substrate to be inserted into and withdrawn from the chamber. Each input/output port 240 is selectively opened and closed by an isolation valve 242.

The loadlock chamber(s) 250 is/are interposed between the transfer chamber 220 and a loading/unloading station 260. The loading/unloading station 260 has an interface robot 262 and includes a plurality of bays each configured to accommodate a substrate storage cassette 264. The loadlocks provide a transition in pressure for the substrates between the vacuum maintained within the transfer chamber 220 and atmospheric pressure prevailing at the loading/unloading station 260. Therefore, a substrate can be readily transferred between the loading/unloading station 260 and the transfer chamber 220.

The present invention will be described with respect to an embodiment in which the calibration tool 100 is employed by a process chamber 210 in which a substrate is supported on a susceptor 212. However, as mentioned above, the calibration tool can be employed in connection with any chamber connected to the central transfer chamber 220 and having a support used to support the substrates that are being transferred into/from the chamber.

In any case, as referred to previously, the process chamber 210 includes a removable upper cover 218 having a shape corresponding to that of the base plate 110 of the calibration tool 100. The susceptor 212 is disposed in the process chamber 210 for supporting a substrate to be processed. The susceptor 212 has a reference mark 214 at a central portion thereof. The reference mark 214 is preferably of reflective material.

The transfer robot 230 is located at a center of the transfer chamber 220 so as to transfer substrates between those chambers connected to the transfer chamber 220. The transfer robot 230 includes an end effecter 232 (also referred to as a blade) for supporting a substrate. A reference hole 234 is formed in the center of the end effecter 232. When the transfer robot 230 is calibrated, i.e., when the position at which the end effecter 232 transfers a substrate onto/from the susceptor 212 is optimal, the reference hole 234 of the end effecter 232 is (vertically) aligned with the reference mark 214 of the susceptor 212.

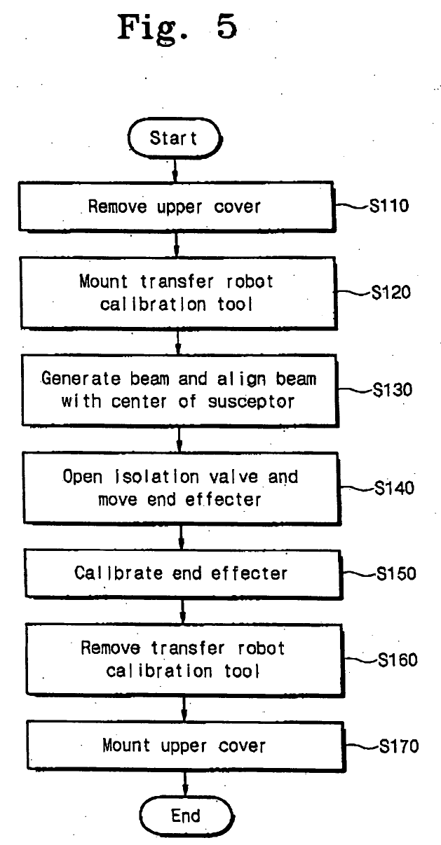

A process of calibrating the transfer robot 230 will now be described step by step with reference to FIGS. 4A-4G and FIG. 5.

Referring first to FIGS. 4A and 5, first, the pressure inside the process chamber 210 is changed from a vacuum pressure to atmospheric pressure, and the upper cover 218 is removed (S110). At this time, the input/output port 240 is closed by the isolation valve 242. Thus, a vacuum is maintained in the transfer chamber 220. Next, as shown in FIG. 4B, the transfer robot calibration tool 100 is mounted to the open upper portion of the process chamber 210 (S120). As a result, the open upper portion of the process chamber 210 is covered by the base plate 110 of the transfer robot calibration tool 100, and a seal is created between the base plate 110 and the process chamber 210.

Then, a technician calibrates the end effecter 232 using the transfer robot calibration tool 100.

First, as is illustrated by FIG. 4C, the position of the light generator 120 (refer back to FIGS. 1 and 2) is adjusted by the technician using the position adjustor 140 so that light emitted by the light generator 120 is incident on the reference mark 214 of the susceptor 212 (S130).

Secondly, as shown in FIG. 4D, the input/output port 240 is opened and the end effecter 232 of the transfer robot 230 is moved into the process chamber 210 (S140). Also, the pressure inside the process chamber 210 is changed from atmospheric pressure to a vacuum pressure after the transfer robot calibration tool 100 has been installed on the process chamber 1210 and before the end effecter 232 is placed in the process chamber 210. Thus, the input/output port 240 is opened while a vacuum is maintained in the process chamber 210.

Thirdly, As illustrated by FIG. 4E, the technician operates a controller (not shown) of the transfer robot 230 to move the end effecter 232 by an amount necessary to place the reference hole 234 of the end effecter 232 in the path of the light emitted by the light generator 120, i.e., so that the reference hole 234 and the reference mark 214 are aligned (S150). In this regard, the technician can check the position of the end effecter 232 by eyeing whether the light passes through the reference hole 234 and illuminates the reference mark 214. Additionally, the transfer robot calibration tool 100 can be used to confirm whether the reference hole 234 formed in the end effecter 232 and the reference mark 214 of the susceptor 212 are aligned, More specifically, the transfer robot calibration tool 100 has an electronic signal processor including a clock to measure the time it takes for a laser beam emitted by the light generator 120 to reflect back to the light detector 130. Thus, the transfer robot calibration tool 100 can determine whether the laser beam emitted by the light generator 120 is reflected from the reference mark 214 of the susceptor 212 or from a surface of the end effecter 232.

Alternatively, the laser beam can be emitted by the light generator 120 at an angle relative to the vertical, and the signal processor can determine the amount of light that is received by the light detector 130. The processor of the transfer robot calibration tool 110 can determine whether the light has been reflected from the reference mark 214 of the susceptor 212 or from a surface of the end effecter 232 based on the amount of light received by the light detector 130. Hence, the transfer robot calibration tool 110 can determine whether the reference hole 234 in the end effecter 232 and the reference mark 214 of the susceptor 212 are aligned.

The transfer robot calibration tool 100 may also include an alarm that signals the technician with the result obtained by the processor. Therefore, the technician can perform the calibration more easily with the help of the light detector 130.

The results of the calibration operation performed by the technician are fed back into the controller of the transfer robot 230. Subsequently, the end effecter 232 is withdrawn back into the transfer chamber 220 from the process chamber 210. Then the input/output port 240 is closed by the isolation valve 242. Finally, as shown in FIGS. 4F and 4G, the transfer robot calibration tool 100 is removed from the process chamber 210 (S160), and the upper cover 218 is reinstalled (S170). Subsequently, the process chamber 210 is evacuated to create a vacuum in the process chamber 210.

As is clear from the above description of the present invention, the process chamber and the transfer chamber are prevented from being contaminated during the calibration of the transfer apparatus because the calibration is performed while a vacuum is maintained in the process chamber. Also, as distinguished from the conventional method in which a great deal of downtime is incurred while both the process chamber and the transfer chamber are evacuated after the transfer robot is calibrated, the present invention allows a vacuum to be maintained in the transfer chamber.

Furthermore, according to the present invention, the calibration of a transfer apparatus can be performed swiftly and accurately.

Still further, the calibration operation of a transfer apparatus can be performed easily by a technician regardless of the level of skill possessed by the technician.

Finally, although the present invention has been described in connection with the preferred embodiments thereof, it is to be understood that the scope of the present invention is not so limited. On the contrary, various modifications of and changes to the preferred embodiments will be apparent to those of ordinary skill in the art. Thus, changes to and modifications of the preferred embodiments may fall within the true spirit and scope of the invention as defined by the appended claims.

What is claimed is:

1. The combination of substrate processing equipment including a transfer chamber, a transfer apparatus installed in the transfer chamber, a process chamber connected to the transfer chamber, an openable and closable input/output defined between the transfer and process chambers and through which substrates can be transferred between the transfer and process chambers, and a substrate support disposed in the process chamber, and wherein the transfer apparatus includes an end effecter having a working envelope encompassing the process chamber such that the end effecter can be moved to a transfer position at which substrates are transferred between the end effecter and the substrate support within the process chamber; and
a transfer apparatus calibration tool by which it can be determined as to whether the end effecter is in a centered state relative to the substrate support when the end effecter is at the transfer position, the transfer apparatus calibration tool comprising a base plate disposed on the process chamber, and an optical system supported by the base plate.

2. The combination of claim 1, wherein the end effecter of the transfer apparatus has a reference hole extending therethrough, and the substrate support has a reference mark thereon, the reference hole of the end effecter and the reference mark of the substrate support being aligned along an optical path of the optical system of the calibration tool when the end effecter is at the transfer position while in a centered state relative to the substrate support.

3. The combination of claim 2, wherein the optical system of the calibration tool comprises a light source mounted to the base plate and oriented to emit light into the process chamber.

4. The combination of claim 1, wherein the base plate of the calibration tool comprises transparent material so that the inside of the process chamber can be viewed from outside the process chamber.

5. The combination of claim 2, wherein the base plate of the calibration tool comprises transparent material so that the inside of the process chamber can be viewed from outside the process chamber.

6. The combination of claim 3, wherein the light source is supported so as to be movable relative to the base plate, whereby the position of the light source relative to the base plate can be adjusted.

7. The combination of claim 3, wherein the optical system of the calibration tool further comprises a light detector.

8. The combination of claim 1, wherein the process chamber has a removable cover, and the base plate of the calibration tool has a shape corresponding to that of the cover and is detachably mounted to the process chamber, whereby the calibration tool can be exchanged with the removable cover of the process chamber.

9. A transfer apparatus calibration tool for use in calibrating a transfer apparatus of substrate processing equipment, the calibration tool comprising:
a base plate comprising transparent material, the base plate having a shape corresponding to a removable cover of a process chamber of substrate processing equipment; and
a light source mounted to the base plate.

10. The calibration tool of claim 9, wherein the entire base plate is transparent.

11. The calibration tool of claim 9, wherein the light source is supported so as to be movable relative to the base plate.

12. The calibration tool of claim 11, further comprising an X-Y stage mounted to the base plate, the X-Y stage comprising a first block supported so as to be movable relative to the base plate in the direction of an X-axis, and a second block supported by said first block so as to be movable with the first block in the direction of the X-axis and relative to the first block in the direction of a Y-axis perpendicular to the X-axis, the and light source being attached to the second block.

13. The calibration tool of claim 9, further comprising a light detector mounted to the base plate.

14. The calibration tool of claim 9, further comprising a battery disposed on the base plate and connected to the light source to supply power to the light source.

15. The calibration tool of claim 4, further comprising a seal extending along the periphery of a lower surface of the base plate.

16. The calibration tool of claim 4, further comprising a support plate extending along one side of the base plate and mounting the light source to the base plate, the support plate having a window confronting the transparent material of the base plate, and the light source being oriented to emit light through the window.

17. The calibration tool of claim 16, wherein the light source is supported so as to be movable along the support plate.

18. The calibration tool of claim 17, further comprising an X-Y stage disposed on the support plate, the X-Y stage comprising a first block supported so as to be movable relative to the base plate in the direction of an X-axis, and a second block supported by said first block so as to be movable with the first block in the direction of the X-axis and relative to the first block in the direction of a Y-axis perpendicular to the X-axis, the light source being attached to the second block.

19. A method for use in operating substrate processing equipment having a transfer chamber, a transfer apparatus installed in the transfer chamber and having an end effecter, a process chamber connected to the transfer chamber, an openable and closable input/output defined between the transfer and process chambers and through which substrates can be transferred between the transfer and process chambers, and a substrate support disposed in the process chamber, the method comprising:
removing a cover of the process chamber, whereby a portion of the process chamber is uncovered, while the input/output port is closed and the end effecter of the transfer apparatus is situated in the transfer chamber;
installing a transfer apparatus calibration tool by mounting the tool to the process chamber over the uncovered portion thereof to hermetically seal the process chamber;
creating a vacuum inside the process chamber sealed by the transfer apparatus calibration tool;
after the vacuum is created in the process chamber, opening the input/output port, and moving the end effecter of the transfer apparatus from the transfer chamber and into the process chamber via the input/output port; and
calibrating the end effecter in the process chamber using the transfer apparatus calibration tool installed over the opened portion of the process chamber, wherein the calibrating comprises determining whether the end effecter is in a centered state relative to the substrate support.

20. The method of claim 19, wherein the calibrating of the end effecter comprises:
directing a beam of light onto a reference mark of the substrate support before the end effecter has been moved into the process chamber, and
after the reference mark has been illuminated and the end effecter has been moved into the process chamber, determining whether the light passes through a reference hole extending through the end effecter.

21. The method of claim 20, wherein the calibrating of the end effecter comprises detecting the beam of light after the light has been reflected in the process chamber, and based on the detection determining whether the beam of light was reflected at the reference mark of the substrate support or at a surface of the end effecter.

22. The method of claim 20, further comprising:
creating atmospheric pressure in the process chamber after the end effecter has been calibrated;
removing the transfer apparatus calibration tool from the process chamber while the inside of the process chamber is at atmospheric pressure, thereby uncovering said portion of the process chamber again;
installing the cover of the process chamber over the uncovered portion thereof; and
subsequently creating a vacuum inside the process chamber.

23. A method for use in operating substrate processing equipment having a transfer chamber, a transfer apparatus installed in the transfer chamber and having an end effecter, a process chamber connected to the transfer chamber, an openable and closable input/output defined between the transfer and process chambers and through which substrates can be transferred between the transfer and process chambers, and a substrate support disposed in the process chamber, the method comprising:
creating a vacuum inside the process chamber;
after the vacuum is created in the process chamber, opening the input/output port, and moving the end effecter of the transfer apparatus from the transfer chamber and into the process chamber via the input/output port; and
calibrating the end effecter by directing a beam of light onto a reference mark of the substrate support, and
after the reference mark has been illuminated, determining whether the light passes through a reference hole extending through the end effecter.

24. The method of claim 23, wherein the calibrating of the end effecter comprises detecting the beam of light after the light has been reflected in the process chamber, and based on the detection determining whether the beam of light was reflected at the reference mark of the substrate support or at a surface of the end effecter.
